(19) United States
(12) Patent Application Publication
(10) Pub. No.: US 2021/0118437 A1
(43) Pub. Date: Apr. 22, 2021

(54) ARTIFICIAL INTELLIGENCE SERVER

(71) Applicant: LG ELECTRONICS INC., Seoul (KR)

(72) Inventor: Dami KIM, Seoul (KR)

(73) Assignee: LG ELECTRONICS INC., Seoul (KR)

(21) Appl. No.: 16/694,807

(22) Filed: Nov. 25, 2019

(30) Foreign Application Priority Data
Oct. 21, 2019 (KR) 10-2019-0130918

(51) Int. Cl. G10L 15/197; G10L 15/22; G10L 15/30; G06N 20/00; G06N 5/04

(52) U.S. Cl. CPC G10L 15/197; G10L 15/22; G10L 2015/223; G06N 20/00; G06N 5/04; G10L 15/30

(57) ABSTRACT

Disclosed is an artificial intelligence (AI) server for speech recognition configured to obtain a candidate group of speech recognition by inputting speech data into a speech recognition model, to obtain a domain corresponding to the speech data, to assign a weight to a plurality of words in the candidate group according to the domain, and to derive a result of speech recognition of rearranging a plurality of candidates in the candidate group of speech recognition.

### CROSS-REFERENCE TO RELATED APPLICATIONS

This application claims priority under 35 U.S.C. 119 and 365 to Korean Patent Application No. 10-2019-0130918, filed on Oct. 21, 2019 in the Korean Intellectual Property Office, the disclosure of which is incorporated herein by reference.

### FIELD

The present disclosure relates to an artificial intelligence (AI) server and method of rearranging results output by analyzing speech data by a speech recognition model according to domain information.

### BACKGROUND

Recently, demands for speech recognition technologies for easy and smooth search in an environment of a mobile device and a smart device have increased, and have been closely connected with outer lives, for example, various electronic devices with an interactive retrieval service installed therein have been introduced. Along with increase in demands for speech recognition technology, there has been a need to enhance the accuracy of the speech recognition technology and to enhance performance for personal optimization search.

Speech recognition means that a feature is extracted from speech data and a pronounced phoneme or word is tracked through a pattern recognition algorithm. An acoustic model and a language model are used as the tracking method, and when an error occurs in the acoustic model and the language model due to wrong estimation, a wrong recognition result is finally and inevitably acquired. Conventionally, in order to compensate for this advantage, there is a method including primary speech recognition of recognizing a keyword from a language model and secondary speech recognition of recognizing speech including the corresponding keyword.

### SUMMARY

An object of the present disclosure is to provide an artificial intelligence (AI) server and method for increasing the accuracy of a speech recognition result related to a corresponding domain upon receiving speech data when a domain corresponding to receive speech data is restricted.

According to an embodiment of the present disclosure, an artificial intelligence (AI) server for speech recognition includes a processor configured to obtain a candidate group of speech recognition by inputting speech data into a speech recognition model, to obtain a domain corresponding to the speech data, to assign a weight to a plurality of words in the candidate group according to the domain, and to derive a result of speech recognition of rearranging a plurality of candidates in the candidate group of speech recognition.

The processor may calculate a plurality of final points corresponding to the plurality of candidates in the candidate group, respectively by combining a point assigned to the plurality of candidates in the candidate group and the weight assigned to the plurality of words in the candidate group, and derives the result of speech recognition by rearranging the plurality of candidates in the candidate group according to the plurality of final points.

A weight assigned to a first word in the candidate group according to the domain may be greater than a weight assigned to a second word in the candidate group according to the domain. In this case, the first word may be a word belonging to the domain only, and the second word may be a word belonging to the domain and other domain.

The processor may obtain a second candidate group of speech recognition by inputting second speech data to the speech recognition model, and may obtain a second domain corresponding to the second speech data, and the processor may assign a weight to a plurality of words in the second candidate group of speech recognition according to the second domain, and may obtain a second result of speech recognition of rearranging a plurality of candidates in the second candidate group of speech recognition.

A weight assigned to a specific word in the candidate group of speech recognition according to the domain may be different from a weight assigned to the specific word in the second candidate group of speech recognition according to the second domain.

### BRIEF DESCRIPTION OF THE DRAWINGS

FIG. 1 is a block diagram illustrating an artificial intelligence (AI) apparatus according to an embodiment of the present disclosure.

FIG. 2 is a block diagram illustrating an AI server according to an embodiment of the present disclosure.

FIG. 3 is a view illustrating an AI system according to an embodiment of the present disclosure.

FIG. 4 is a block diagram illustrating an AI apparatus according to an embodiment of the present disclosure.

FIG. 5 is a view illustrating an AI server according to an embodiment of the present disclosure.

FIG. 6 is a flowchart illustrating a general method of recognizing user speech.

FIG. 7 is a flowchart according to an embodiment of the present disclosure.

FIG. 8 is a flowchart showing rearrangement according to an embodiment of the present disclosure.

FIG. 9 is a view illustrating a candidate group rearrangement result according to an embodiment of the present disclosure.

FIG. 10 is a view illustrating a procedure of performing speech recognition by a server according to an embodiment of the present disclosure.

### DETAILED DESCRIPTION

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “interface” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

Artificial Intelligence (AI)

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of learning an artificial neural network in a state in which a label for training data is given, and the label may mean the correct answer (or result value) that the artificial neural network must infer when the training data is input to the artificial neural network. The unsupervised learning may refer to a method of learning an artificial neural network in a state in which a label for training data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

Robot

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving interface may include an actuator or a motor and may perform various physical operations such as moving a robot joint. In addition, a movable robot may include a wheel, a brake, a propeller, and the like in a driving interface, and may travel on the ground through the driving interface or fly in the air.

Self-Driving

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

Here, the self-driving vehicle may be regarded as a robot having a self-driving function.

eXtended Reality (XR)

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are shown together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

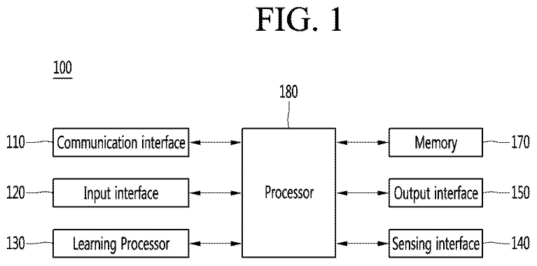

FIG. 1 is a block diagram illustrating an AI apparatus 100 according to an embodiment of the present disclosure.

Hereinafter, the AI apparatus 100 may be referred to as a terminal.

The AI apparatus (or an AI device) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI apparatus 100 may include a communication interface 110, an input interface 120, a learning processor 130, a sensing interface 140, an output interface 150, a memory 170, and a processor 180.

The communication interface 110 may transmit and receive data to and from external devices such as other 100a to 100e and the AI server 200 by using wire/wireless communication technology. For example, the communication interface 110 may transmit and receive sensor information, a user input, a learning model, and a control signal to and from external devices.

The communication technology used by the communication interface 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input interface 120 may acquire various kinds of data.

Here, the input interface 120 may include a camera for inputting a video signal, a microphone for receiving an audio signal, and a user input interface for receiving information from a user. The camera or the microphone may be treated as a sensor, and the signal acquired from the camera or the microphone may be referred to as sensing data or sensor information.

The input interface 120 may acquire a training data for model learning and an input data to be used when an output is acquired by using learning model. The input interface 120 may acquire raw input data. Here, the processor 180 or the learning processor 130 may extract an input feature by preprocessing the input data.

The learning processor 130 may learn a model composed of an artificial neural network by using training data. The learned artificial neural network may be referred to as a learning model. The learning model may be used to an infer result value for new input data rather than training data, and the inferred value may be used as a basis for determination to perform a certain operation.

Here, the learning processor 130 may perform AI processing together with the learning processor 240 of the AI server 200.

Here, the learning processor 130 may include a memory integrated or implemented in the AI apparatus 100. Alternatively, the learning processor 130 may be implemented by using the memory 170, an external memory directly connected to the AI apparatus 100, or a memory held in an external device.

The sensing interface 140 may acquire at least one of internal information about the AI apparatus 100, ambient environment information about the AI apparatus 100, and user information by using various sensors.

Examples of the sensors included in the sensing interface 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output interface 150 may generate an output related to a visual sense, an auditory sense, or a haptic sense.

Here, the output interface 150 may include a display interface for outputting time information, a speaker for outputting auditory information, and a haptic module for outputting haptic information.

The memory 170 may store data that supports various functions of the AI apparatus 100. For example, the memory 170 may store input data acquired by the input interface 120, training data, a learning model, a learning history, and the like.

The processor 180 may determine at least one executable operation of the AI apparatus 100 based on information determined or generated by using a data analysis algorithm or a machine learning algorithm. The processor 180 may control the components of the AI apparatus 100 to execute the determined operation.

To this end, the processor 180 may request, search, receive, or utilize data of the learning processor 130 or the memory 170. The processor 180 may control the components of the AI apparatus 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI apparatus 100 so as to drive an application program stored in memory 170. Furthermore, the processor 180 may operate two or more of the components included in the AI apparatus 100 in combination so as to drive the application program.

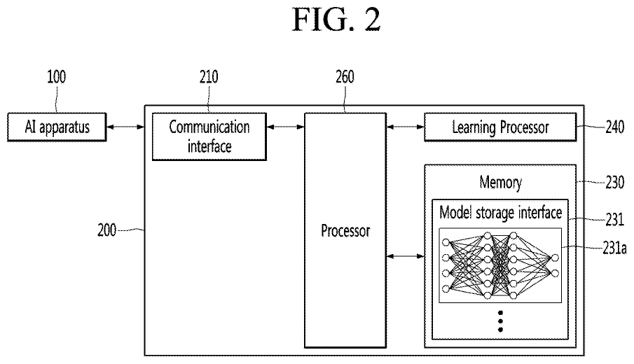

FIG. 2 is a block diagram illustrating an AI server 200 according to an embodiment of the present disclosure.

Referring to FIG. 2, the AI server 200 may refer to a device that learns an artificial neural network by using a machine learning algorithm or uses a learned artificial neural network. The AI server 200 may include a plurality of servers to perform distributed processing, or may be defined as a 5G network. Here, the AI server 200 may be included as a partial configuration of the AI apparatus 100, and may perform at least part of the AI processing together.

The AI server 200 may include a communication interface 210, a memory 230, a learning processor 240, a processor 260, and the like.

The communication interface 210 can transmit and receive data to and from an external device such as the AI apparatus 100.

The memory 230 may include a model storage interface 231. The model storage interface 231 may store a learning or learned model (or an artificial neural network 231a) through the learning processor 240.

The learning processor 240 may learn the artificial neural network 231a by using the training data. The learning model may be used in a state of being mounted on the AI server 200 of the artificial neural network, or may be used in a state of being mounted on an external device such as the AI apparatus 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

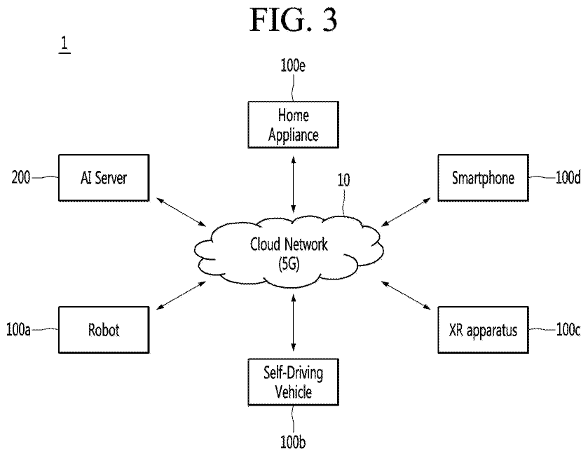

FIG. 3 is a view illustrating an AI system 1 according to an embodiment of the present disclosure.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI apparatuses 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

That is, the devices 100a to 100e and 200 configuring the AI system 1 may be connected to each other through the cloud network 10. In particular, each of the devices 100a to 100e and 200 may communicate with each other through a base station, but may directly communicate with each other without using a base station.

The AI server 200 may include a server that performs AI processing and a server that performs operations on big data.

The AI server 200 may be connected to at least one of the AI apparatuses constituting the AI system 1, that is, the robot 100a, the self-driving vehicle 100b, the XR device 100c, the smartphone 100d, or the home appliance 100e through the cloud network 10, and may assist at least part of AI processing of the connected AI apparatuses 100a to 100e.

Here, the AI server 200 may learn the artificial neural network according to the machine learning algorithm instead of the AI apparatuses 100a to 100e, and may directly store the learning model or transmit the learning model to the AI apparatuses 100a to 100e.

Here, the AI server 200 may receive input data from the AI apparatuses 100a to 100e, may infer the result value for the received input data by using the learning model, may generate a response or a control command based on the inferred result value, and may transmit the response or the control command to the AI apparatuses 100a to 100e.

Alternatively, the AI apparatuses 100a to 100e may infer the result value for the input data by directly using the learning model, and may generate the response or the control command based on the inference result.

Hereinafter, various embodiments of the AI apparatuses 100a to 100e to which the above-described technology is applied will be described. The AI apparatuses 100a to 100e illustrated in FIG. 3 may be regarded as a specific embodiment of the AI apparatus 100 illustrated in FIG. 1.

AI+Robot

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model composed of at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

Here, the robot 100a may perform the operation by generating the result by directly using the learning model, but the sensor information may be transmitted to the external device such as the AI server 200 and the generated result may be received to perform the operation.

The robot 100a may use at least one of the map data, the object information detected from the sensor information, or the object information acquired from the external device to determine the travel route and the travel plan, and may control the driving interface such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving interface based on the control/interaction of the user. Here, the robot 100a may acquire the intention information of the interaction due to the user's operation or speech utterance, and may determine the response based on the acquired intention information, and may perform the operation.

AI+Self-Driving

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the route and the travel plan, or may determine the operation.

Like the robot 100a, the self-driving vehicle 100b may use the sensor information acquired from at least one sensor among the lidar, the radar, and the camera so as to determine the travel route and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling route by using the recognized surrounding information or object information. The learning model may be learned directly from the self-driving vehicle 100a or may be learned from an external device such as the AI server 200.

Here, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external device to determine the travel route and the travel plan, and may control the driving interface such that the self-driving vehicle 100b travels along the determined travel route and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving interface based on the control/interaction of the user. Here, the self-driving vehicle 100b may acquire the intention information of the interaction due to the user's operation or speech utterance, and may determine the response based on the acquired intention information, and may perform the operation.

AI+XR

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

Here, the XR device 100c may perform the operation by generating the result by directly using the learning model, but the sensor information may be transmitted to the external device such as the AI server 200 and the generated result may be received to perform the operation.

AI+Robot+Self-Driving

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given route without the user's control or moves for itself by determining the route by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

Here, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving interface of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

AI+Robot+XR

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot that is subjected to control/interaction in an XR image. In this case, the robot 100a may be separated from the XR device 100c and interwork with each other.

When the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user can confirm the XR image corresponding to the time point of the robot 100a interworking remotely through the external device such as the XR device 100c, adjust the self-driving travel path of the robot 100a through interaction, control the operation or driving, or confirm the information about the surrounding object.

AI+Self-Driving+XR

The self-driving vehicle 100b, to which the AI technology and the XR technology are applied, may be implemented as a mobile robot, a vehicle, an unmanned flying vehicle, or the like.

The self-driving driving vehicle 100b, to which the XR technology is applied, may refer to a self-driving vehicle having a means for providing an XR image or a self-driving vehicle that is subjected to control/interaction in an XR image. Particularly, the self-driving vehicle 100b that is subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

Here, when the XR object is output to the HUD, at least part of the XR object may be outputted so as to overlap the actual object to which the passenger's gaze is directed. Meanwhile, when the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

When the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

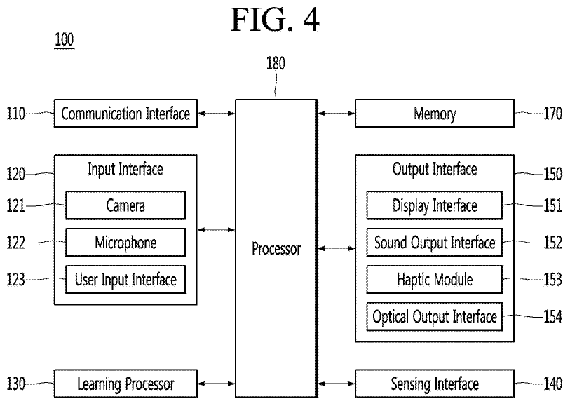

FIG. 4 is a block diagram illustrating an AI apparatus 100 according to an embodiment of the present disclosure.

The redundant repeat of FIG. 1 will be omitted below.

In the present disclosure, the AI apparatus 100 may include an edge device.

The communication interface 110 may also be referred to as a communicator.

Referring to FIG. 4, the input interface 120 may include a camera 121 for image signal input, a microphone 122 for receiving audio signal input, and a user input interface 123 for receiving information from a user.

Voice data or image data collected by the input interface 120 are analyzed and processed as a user's control command.

Then, the input interface 120 is used for inputting image information (or signal), audio information (or signal), data, or information inputted from a user and the AI apparatus 100 may include at least one camera 121 in order for inputting image information.

The camera 121 processes image frames such as a still image or a video obtained by an image sensor in a video call mode or a capturing mode. The processed image frame may be displayed on the display interface 151 or stored in the memory 170.

The microphone 122 processes external sound signals as electrical voice data. The processed voice data may be utilized variously according to a function (or an application program being executed) being performed in the AI apparatus 100. Moreover, various noise canceling algorithms for removing noise occurring during the reception of external sound signals may be implemented in the microphone 122.

The user input interface 123 is to receive information from a user and when information is inputted through the user input interface 123, the processor 180 may control an operation of the AI apparatus 100 to correspond to the inputted information.

The user input interface 123 may include a mechanical input means (or a mechanical key, for example, a button, a dome switch, a jog wheel, and a jog switch at the front, back or side of the AI apparatus 100) and a touch type input means. As one example, a touch type input means may include a virtual key, a soft key, or a visual key, which is displayed on a touch screen through software processing or may include a touch key disposed at a portion other than the touch screen.

The sensing interface 140 may also be referred to as a sensor interface.

The output interface 150 may include at least one of a display interface 151, a sound output module 152, a haptic module 153, or an optical output module 154.

The display interface 151 may display (output) information processed in the AI apparatus 100. For example, the display interface 151 may display execution screen information of an application program running on the AI apparatus 100 or user interface (UI) and graphic user interface (GUI) information according to such execution screen information.

The display interface 151 may be formed with a mutual layer structure with a touch sensor or formed integrally, so that a touch screen may be implemented. Such a touch screen may serve as the user input interface 123 providing an input interface between the AI apparatus 100 and a user, and an output interface between the AI apparatus 100 and a user at the same time.

The sound output module 152 may output audio data received from the wireless communication interface 110 or stored in the memory 170 in a call signal reception or call mode, a recording mode, a voice recognition mode, or a broadcast reception mode.

The sound output module 152 may include a receiver, a speaker, and a buzzer.

The haptic module 153 generates various haptic effects that a user can feel. A representative example of a haptic effect that the haptic module 153 generates is vibration.

The optical output module 154 outputs a signal for notifying event occurrence by using light of a light source of the AI apparatus 100. An example of an event occurring in the AI apparatus 100 includes message reception, call signal reception, missed calls, alarm, schedule notification, e-mail reception, and information reception through an application.

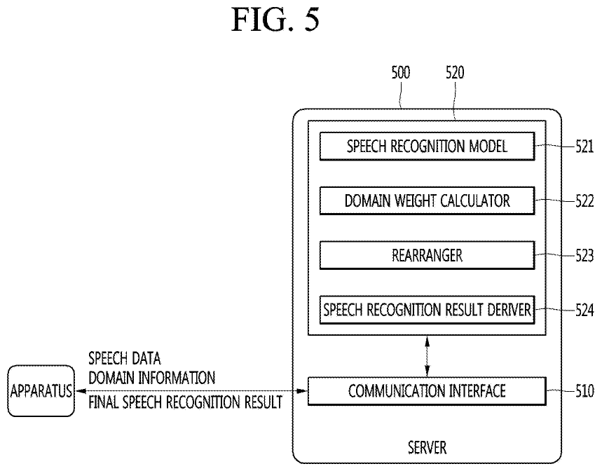

### FIG. 5 is a View Illustrating an AI Server 500 According to an Embodiment of the Present Disclosure

The AI server 500 may include the configuration of the AI apparatus 100 described with reference to FIG. 1 and may perform a function of the AI apparatus 100. Hereinafter, a repeated description of FIG. 1 is omitted.

Referring to FIG. 5, the AI server 500 may include a processor 520 and a communication interface 510. The communication interface 510 may communicate with various apparatuses and may receive speech data and domain information corresponding to the speech data. The processor 520 may include a speech recognition model 521, a domain weight calculator 522, a rearranger 523, and a speech recognition result deriver 524.

In detail, the processor 520 may derive a speech recognition result using the speech data and domain information received from the communication interface 510. When the communication interface 510 receives the speech data and the domain information corresponding to the speech data from an apparatus, the processor 520 may input the speech data acquired from the communication interface 510 to the speech recognition model 521 and may acquire a candidate group of speech recognition.

The domain weight calculator 522 may acquire a word corresponding to the domain information using the domain information received from the communication interface 510, and may assign a weight to a plurality of words in the candidate group of speech recognition.

The rearranger 523 may combine a point assigned to the candidates in the candidate group and the weight assigned by the domain weight calculator 522 and may calculate final points corresponding to the plurality of candidates in the candidate group of speech recognition, respectively. The rearranger 523 may rearrange the plurality of candidates in the candidate group of speech recognition in descending order of points according to each of the calculated final points.

The speech recognition result deriver 524 may derive a candidate with a highest point among the plurality of candidates rearranged by the rearranger 523 as the speech recognition result. Then, upon receiving the speech recognition result from the processor 520, the communication interface 510 may transmit the final speech recognition result to an apparatus that transmits speech data so as to enable the apparatus to execute a command based on the speech recognition result.

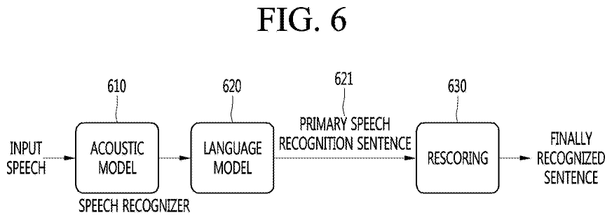

### FIG. 6 is a Flowchart Illustrating a General Method of Recognizing User Speech

Referring to FIG. 6, speech recognition may refer to a technology of analyzing a speech signal uttered by the human and automatically converting the speech signal into a string and may include an acoustic model, a language model, and rescoring.

In detail, an acoustic model 610 included in a speech recognizer may have installed therein a statistical or patterned model of a feature according to pronunciation of a phoneme of a corresponding language and may obtain a phoneme model with respect to a speech signal input during a phoneme decoding procedure. A language model 620 may have installed therein a statistical or patterned model of text data of a word of a corresponding language and may output an N-best word extracted from the phoneme model transferred from the acoustic model 610.

A rescoring 630 may compare and score a feature vector of an input speech signal using N-best words output from the language model based on a model and may output a result of speech recognition. In addition, due to the property of Korean using pseudo morpheme, the speech recognition may also include a post-processing model for reconfiguring a word.

The N-best word may be interchangeably used with the candidate group of speech recognition according to the present disclosure, and the speech recognizer may be interchangeably used with the speech recognition model.

Hereinafter, flowcharts according to the present disclosure will be described.

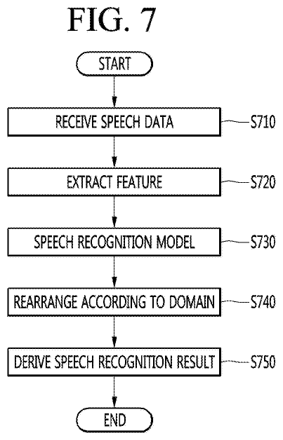

### FIG. 7 is a Flowchart According to an Embodiment of the Present Disclosure

Referring to FIG. 7, the communication interface 510 of the AI server 500 may receive speech data of speech uttered by a user (S710). The speech data uttered by the user may be received from an external apparatus (not shown) through the communication interface 510.

The processor 520 may extract a feature vector of the speech data acquired from the communication interface 510 (S720). In detail, the processor 520 may receive the speech data, and may convert the speech data into a feature vector useful for speech recognition using a method such as a Mel-Frequency Cepstral Coefficient. A procedure of extracting the feature vector may be interchangeably used with speech recognition result processing. A signal processing procedure for noise processing may be further performed after the feature vector is extracted for speech recognition.

The processor 180 may input the feature vector extracted during the above procedure to the speech recognition model 521. The speech recognition model 521 may include a global language model and may generate candidate groups of speech recognition that are rearranged in descending order of points as a result output from the global language model using the input speech data (S730).

According to an embodiment of the present disclosure, the speech recognition model 521 may include an acoustic model for extracting a phoneme and a language model for extracting N-best words using the phoneme extracted by the acoustic model, and may include a neural network trained using a machine learning algorithm. In this case, an N-best sentence may be interchangeably used with the candidate group of speech recognition.

In detail, the speech recognition model 521 may have installed therein the acoustic model 610 that is a statistical or patterned model of a feature according to pronunciation of a phoneme of a corresponding language, as described with reference to FIG. 6.

That is, the processor 520 may recognize a sound signal input in units of phonemes using the acoustic model 610. The processor 520 may obtain a phoneme model using the recognition result in units of phonemes, may generate at least one sentence corresponding to the input speech data using the language model 620, and may output the candidate group of speech recognition.

The aforementioned acoustic model or language model may be a model trained using a machine learning algorithm or a deep learning algorithm and may include a neural network. Learning of the acoustic model 610 or the language model 620 may be performed by the learning processor 130 of the AI apparatus 100. In addition, learning of the acoustic model 610 or the language model 620 may also be performed by the learning processor 240 of the AI server 200.

The acoustic model or the language model may be stored in a memory (not shown) of the AI server 500. In addition, the acoustic model or the language model may also be stored in the memory 230 of the AI server 200.

The processor 520 may input the received speech data to the speech recognition model 521 to calculate a language model score and may generate candidate groups of speech recognition in descending order.

According to an embodiment of the present disclosure, the processor 520 may acquire a domain corresponding to the speech data and may acquire a word corresponding to the domain information. The processor 520 may assign a weight to a plurality of words in the candidate groups of speech recognition and may rearrange a plurality of candidates in the candidate group of speech recognition (S740).

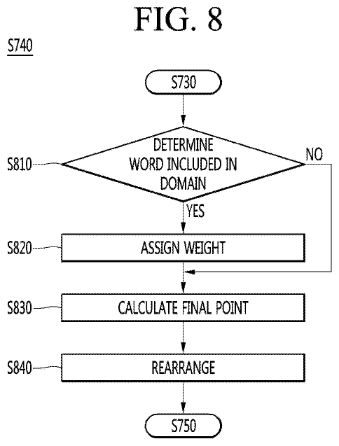

In detail, upon determining that a word appropriate for the acquired domain is present in a word in the candidate group of speech recognition extracted by the speech recognition model 521, the processor 520 may assign a weight to the corresponding word, may rescore each of the plurality of candidates in the candidate group, and may re-arrange the plurality of candidates according to the rescoring result, which will be described in detail with reference to FIG. 8.

The processor 520 may derive a speech recognition candidate with a highest point among the plurality of rearranged candidates as a final speech recognition result (S750).

In this case, the domain may include information acquired by receiving information or state information of an apparatus that transmits the speech data. For example, the domain may refer to a topic such as a weather menu, a sightseeing menu, an electronic device, and state information of the electronic device.

In detail, the AI server 500 may classify a plurality of domains for respective topics, may select keywords for the respective domains, and may include a domain database for storing the keyword in a database. In this case, the domain database may include a semantic category such as sightseeing or weather in each keyword. In addition, the domain database may include a use category such as an electronic device and state information of the electronic device.

The processor 520 may store the speech recognition result in a memory (not shown). In addition, the processor 520 may control an output interface to output the speech recognition result.

### FIG. 8 is a Flowchart Showing Rearrangement According to an Embodiment of the Present Disclosure

Referring to FIG. 8, in order to rearrange a plurality of candidates in the candidate group of speech recognition acquired through the speech recognition model as a result of assigning a weight according to a domain, the processor 520 of the AI server 500 may acquire a domain corresponding to the speech data acquired by the communication interface 510 and may acquire a word corresponding to the domain.

In detail, the processor 180 may detect a word included in the domain among words included in the candidate group of speech recognition, arranged according to a language model score (S810). The detected word may be a keyword of the domain. In this case, the keyword may include at least one word set with a weight assigned thereto in a domain.

The processor 520 may assign a weight when a word included in the candidate group of speech recognition is a word included in the domain (S820). In detail, a first weight may be assigned to a first word in the candidate group according to the domain and a second weight may be assigned to a second word in the candidate group according to the domain. The first weight assigned to the first word in the candidate group may be greater than the second weight assigned to the second word.

For example, upon receiving speech data from a refrigerator, the processor 520 included in the AI server 500 may acquire domain information of ‘refrigerator’. ‘Water’ as the first word and ‘cup’ as the second word may be stored in the refrigerator domain. It is assumed that a speech recognition candidate of ‘I want a cup of water’ is derived as a result of inputting speech data of a user to the speech recognition model 521. The processor 520 may assign the first weight to ‘water’ and may assign the second weight to ‘cup’. In this case, the first weight may be greater than the second weight.

According to an embodiment of the present disclosure, the first word may be a word belonging to the domain only, and the second word may be a word belonging to the domain and other domain.

In detail, even if words are included in the same domain, weights assigned to the words may be set to be different according to importance thereof.

The importance may be set to be higher than a specific value in the case of a word belonging to the corresponding domain, and may be set to be lower than the specific value in the case of a word that commonly belongs to the domain and other domains. For example, upon receiving speech data from a washing machine, the processor 520 included in an AI server may acquire domain information of ‘washing machine’. ‘Laundry’ as the first word and ‘temperature’ as the second word may be included in a washing machine domain. In this case, ‘laundry’ as the first word may be the first word belonging to the washing machine domain only, and the ‘temperature’ may be the second word that is included in other domains including a refrigerator domain or an air conditioner domain as well as the washing machine domain. In this case, ‘laundry’ as the first word may have higher importance than ‘temperature’ as the second word in the washing machine domain, and thus, may be set with a higher weight than a specific value.

According to an embodiment of the present disclosure, a weight assigned to a specific word in the candidate group of speech recognition according to the domain may be different from a weight assigned to the specific word in the second candidate group of speech recognition according to the second domain.

In detail, despite the same word, importance thereof is changed according to a domain, and thus a weight assigned to a specific word in a candidate group may be changed. For example, assuming that a first domain is a washing machine domain and a second domain is an air conditioner domain, weights assigned to ‘temperature’ commonly included in the first domain and the second domain may be different from each other.

Then, the processor 520 may combine points and weights assigned to a plurality of candidates in the candidate group in operation 5820 and may calculate a plurality of final points corresponding to candidates in the candidate group, respectively (S830).

In detail, the processor 520 may calculate a final point using operation expression as a method of calculating final points of the plurality of candidates in the candidate group. In this case, the operation expression may include the following operation expression in which a first adjustment weight is α_{D}_{ᵢ}, a second adjustment weight is β_{D}_{ᵢ}, a domain is Dᵢ, a point of a candidate of a candidate group of speech recognition is δ, a plurality of words in the candidate group of speech recognition is W, and a weight according to domain Dᵢ is λ_{ω}, but the present disclosure is not limited thereto.

α_{D}_{ᵢ}δ+β_{D}_{ᵢ}Σ_{ω∈W}λ_{ω} 1)

α_{D}_{ᵢ}δ×β_{D}_{ᵢ}Σ_{ω∈W}λ_{ω} 2)

α_{D}_{ᵢ}δ+β_{D}_{ᵢ}Π_{ω∈W}λ_{ω} 3)

α_{D}_{ᵢ}δ×β_{D}_{ᵢ}Π_{ω∈W}λ_{ω} 4)

In more detail, the final point may be calculated via addition or multiplication of a ‘value obtained by adding the first adjustment weight α_{D}_{ᵢ} to a first value δ as a point assigned to a specific candidate in the candidate group’ and a ‘value obtained by adding or multiplying the weight λ_{ω} assigned to a word in the specific candidate and the second adjustment weight β_{D}_{ᵢ}’.

The processor 520 may rearrange the plurality of candidates according to the acquired final point and may acquire the speech recognition result (S840).

Through the above procedure, the processor 520 may rescore the language model score using the operation expression (S830), may rearrange the plurality of candidates in the candidate group of speech recognition in descending order of points to derive a speech recognition candidate with a highest point (S840), and may acquire a final speech recognition result (S750).

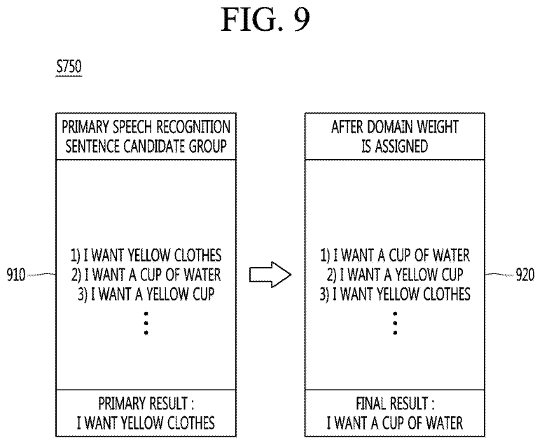

FIG. 9 is a view illustrating a candidate group rearrangement result according to an embodiment of the present disclosure.

Referring to FIG. 9, the processor 520 included in the AI server 500 may acquire a primary result that is a candidate group 910 of a speech recognition sentence and may acquire a candidate group 920 rearranged through the above procedure. For example, when speech recognition in a refrigerator is performed, when the communication interface 510 receives ‘I want a cup of water’, the processor 520 may input speech data ‘I want a cup of water’ to the speech recognition model 521. The speech recognition model 521 may acquire a candidate group such as 1) I want yellow clothes, 2) I want a cup of water, and 3) I want a yellow cup as a result of deriving a plurality of candidates in the candidate group of speech recognition in descending order.

The processor 520 may acquire ‘water’ and ‘cup’ as a word included in the refrigerator domain and may assign a weight to ‘water’ and ‘cup’ among words in the candidate group of speech recognition to re-score a point of each of the plurality of candidates. The plurality of candidates in the candidate group may be rearranged in descending order according to the rescoring result. As the result, the plurality of candidates may be rearranged in the order of 1) I want a cup of water, 2) I want a yellow cup, and 3) I want yellow clothes.

The processor 520 may derive 1) I want a cup of water as the final speech recognition result. The derived result may be transmitted to the refrigerator through the communication interface 510, and the refrigerator that receives the speech recognition result may execute a corresponding command.

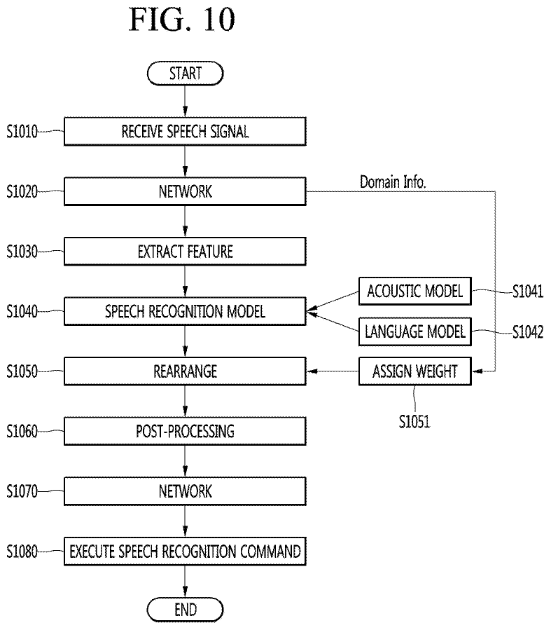

### FIG. 10 is a View Illustrating a Procedure of Performing Speech Recognition by a Server According to an Embodiment of the Present Disclosure

Referring to FIG. 10, the communication interface 510 included in the AI server 500 may receive the speech signal and domain information from an external device or apparatus through a network (S1010 and S1020). The processor 520 included in the AI server 500 may extract a feature of the speech data received thorough speech recognition result processing (S1030). In addition, the extracted feature may be input to the speech recognition model including an acoustic model and a language model to acquire candidate group of speech recognition (S1040). The processor 520 may acquire a word included in the acquired domain and may assign a weight to a plurality of words in the candidate group of speech recognition (S1051). The word included in the domain may be a value that is already stored in the AI server 500. Then, the plurality of candidates in the candidate group of speech recognition may be rescored using the operation expression, and the plurality of acquire candidates may be rearranged in descending order of points (S1050). The processor may derive a candidate with a highest point among the plurality of rearranged candidates in the candidate group as a speech recognition result. Then, the processor 520 may perform post-processing (S1060). In this case, post-processing may include the following information that is executed according to an application.

First, when a speech recognition result is simply shown as a text, the speech recognition result may be corrected to be easily read by a user.

Second, when an operation is performed according to the speech recognition result, an intention may be recognized through natural language processing and then a protocol for performing the corresponding operation may be transferred. For example, when the speech recognition result is ‘Control temperature of air conditioner to 18 degrees’, a protocol for controlling the air conditioner temperature.

The processor 520 may transfer the post-processing result to an external device or apparatus through a network and may control the corresponding external device or apparatus to execute a command of speech recognition (S1080).

According to the present disclosure, a speech recognition method may include input speech data to a speech recognition model to acquire a candidate group of speech recognition, acquiring a domain corresponding to the speech data, and assigning a weight to a plurality of words in the candidate group of speech recognition according to the domain to derive a speech recognition result of rearranging a plurality of candidates in the candidate group of speech recognition.

The assigning the weight to the plurality of words in the candidate group of speech recognition according to the domain to deriving the speech recognition result of rearranging the plurality of candidates in the candidate group of speech recognition may include combining a point assigned to the plurality of candidates in the candidate group and a weight assigned to the plurality of words in the candidate group to calculate a plurality of final points corresponding to the plurality of candidates in the candidate group, respectively, and deriving the speech recognition result of rearranging the plurality of candidates in the candidate group according to the plurality of final points.

The weight assigned to the first word in the candidate group according to the domain may be greater than the weight assigned to the second word in the candidate group.

The first word may be a word belonging to the domain only, and the second word may be a word belonging to the domain and other domain.

The domain may be a weight combination corresponding to at least one word and may be determined depending on information on an apparatus that transmits the speech data or state information of the apparatus.

The speech recognition method may further include inputting the second speech data to the speech recognition model to acquire a second candidate group of speech recognition; acquiring a second domain corresponding to the second speech data; and assigning a weight to a plurality of words in the second candidate group of speech recognition according to the second domain and acquiring a second result of speech recognition of rearranging a plurality of candidates in the second candidate group of speech recognition.

The weight assigned to the specific word in the candidate group of speech recognition according to the domain may be different from a weight assigned to the specific word in the second candidate group of speech recognition according to the second domain.

The speech recognition model may include a global language model, and results output from the global language model may be arranged in descending order to generate the candidate group of speech recognition.

The above operations may not be limited to a temporal sequence, and some operations may be omitted. In addition, a sequence of some operations may be changed and the operations may be performed.

As described above, the plurality of candidates in the candidate group of speech recognition acquired from the speech recognition model may be rearranged by assigning a weight to the plurality of words in the candidate group according to a domain corresponding to speech data, and thus compared with a conventional speech recognition model, the probability of deriving a speech recognition result appropriate for a corresponding domain may be increased to enhance speech recognition performance.

Compared with a conventional model, domain information may be acquired from an apparatus that transmits speech data, and thus a separate procedure of acquiring a domain is not required, thereby reducing a burden of hardware.

According to an embodiment of the present disclosure, the above-described method may be implemented as a processor-readable code in a medium where a program is recorded. Examples of a processor-readable medium may include hard disk drive (HDD), solid state drive (SSD), silicon disk drive (SDD), read-only memory (ROM), random access memory (RAM), CD-ROM, a magnetic tape, a floppy disk, and an optical data storage device.

What is claimed is:

1. An artificial intelligence (AI) server for speech recognition, comprising:
a processor configured to obtain a candidate group of speech recognition by inputting speech data into a speech recognition model, to obtain a domain corresponding to the speech data, to assign a weight to a plurality of words in the candidate group according to the domain, and to derive a result of speech recognition of rearranging a plurality of candidates in the candidate group of speech recognition.

2. The AI server for speech recognition of claim 1, wherein the processor calculates a plurality of final points corresponding to the plurality of candidates in the candidate group, respectively by combining a point assigned to the plurality of candidates in the candidate group and the weight assigned to the plurality of words in the candidate group, and derives the result of speech recognition by rearranging the plurality of candidates in the candidate group according to the plurality of final points.

3. The AI server for speech recognition of claim 2, wherein a weight assigned to a first word in the candidate group according to the domain is greater than a weight assigned to a second word in the candidate group according to the domain.

4. The AI server for speech recognition of claim 3, wherein the first word is a word belonging to the domain only; and
wherein the second word is a word belonging to the domain and other domain.

5. The AI server for speech recognition of claim 1, further comprising a communication interface configured to receive the speech data,
wherein the domain is determined depending on information of an apparatus that transmits the speech data or state information of the apparatus.

6. The AI server for speech recognition of claim 1, wherein the processor obtains a second candidate group of speech recognition by inputting second speech data to the speech recognition model, and obtains a second domain corresponding to the second speech data; and
wherein the processor assigns a weight to a plurality of words in the second candidate group of speech recognition according to the second domain, and obtains a second result of speech recognition of rearranging a plurality of candidates in the second candidate group of speech recognition.

7. The AI server for speech recognition of claim 6, wherein a weight assigned to a specific word in the candidate group of speech recognition according to the domain is different from a weight assigned to the specific word in the second candidate group of speech recognition according to the second domain.

8. The AI server for speech recognition of claim 1, wherein the speech recognition model includes a global language model; and
wherein the candidate group of speech recognition is generated by arranging results of output from the global language model in descending order of points.

9. A speech recognition method comprising:
obtaining a candidate group of speech recognition inputting speech data into a speech recognition model;
obtaining a domain corresponding to the speech data;
assigning a weight to a plurality of words in the candidate group according to the domain, and deriving a result of speech recognition of rearranging a plurality of candidates in the candidate group of speech recognition.

10. The speech recognition method of claim 9, wherein the assigning the weight includes:
calculating a plurality of final points corresponding to the plurality of candidates in the candidate group, respectively by combining a point assigned to the plurality of candidates in the candidate group and the weight assigned to the plurality of words in the candidate group, and deriving the result of speech recognition by rearranging the plurality of candidates in the candidate group according to the plurality of final points.

11. The speech recognition method of claim 10, wherein a weight assigned to a first word in the candidate group according to the domain is greater than a weight assigned to a second word in the candidate group according to the domain.

12. The speech recognition method of claim 11, wherein the first word is a word belonging to the domain only; and
wherein the second word is a word belonging to the domain and other domain.

13. The speech recognition method of claim 9, wherein the domain is a weight combination corresponding to at least one word and is determined depending on information of an apparatus that transmits the speech data or state information of the apparatus.

14. The speech recognition method of claim 9, further comprising:
obtaining a second candidate group of speech recognition by inputting second speech data to the speech recognition model;
obtaining a second domain corresponding to the second speech data; and
assigning a weight to a plurality of words in the second candidate group of speech recognition according to the second domain, and obtaining a second result of speech recognition of rearranging a plurality of candidates in the second candidate group of speech recognition.

15. The speech recognition method of claim 14, wherein a weight assigned to a specific word in the candidate group of speech recognition according to the domain is different from a weight assigned to the specific word in the second candidate group of speech recognition according to the second domain.

16. The speech recognition method of claim 9, wherein the speech recognition model includes a global language model; and
wherein the candidate group of speech recognition is generated by arranging results of output from the global language model in descending order of points.
